(19) United States
(12) Patent Application Publication
(10) Pub. No.: US 2020/0030745 A1
(43) Pub. Date: Jan. 30, 2020

(54) CATALYST FOR REDUCTION OF NITROGEN OXIDES

(71) Applicant: UMICORE AG & CO. KG, Hanau-Wolfgang (DE)

(72) Inventors: Thomas UTSCHIG, Frankfurt am Main (DE); Ruediger HOYER, Alzenau-Hoerstein (DE); Naohiro KATO, Himeji, Hyogo (JP)

(73) Assignee: Umicore AG & Co. KG, Hanau-Wolfgang (DE)

(21) Appl. No.: 15/999,685

(22) PCT Filed: Feb. 21, 2017
(86) PCT No.: PCT/EP2017/053825

§ 371 Date: Aug. 20, 2018

(30) Foreign Application Priority Data
Feb. 22, 2016 (DE) 10 2016 103 034.1

(51) Int. Cl. B01D 53/94; B01J 35/00; B01J 23/656; B01J 23/63; B01J 35/10; B01J 37/02; B01J 37/08; B01J 37/00

(52) U.S. Cl. CPC B01D 53/9422; B01D 2255/9205; B01J 23/6562; B01J 23/63; B01J 35/0073; B01J 35/1076; B01J 37/0244; B01J 37/088; B01J 37/0018; B01D 2255/1021; B01D 2255/1023; B01D 2255/1025; B01D 2255/202; B01D 2255/204; B01D 2255/2047; B01D 2255/2063; B01D 2255/2065; B01D 2255/2073; B01D 2255/9022; B01D 2255/91; B01J 35/0006

(57) ABSTRACT

The invention relates to a nitrogen oxide storage catalyst composed of at least two catalytically active washcoat layers on a support body, wherein a lower washcoat layer A comprises cerium oxide, an alkaline earth metal compound and/or an alkali compound, platinum and palladium, and an upper washcoat layer B located above washcoat layer A comprises cerium oxide, platinum and palladium, does not contain any alkali and alkaline-earth compounds, and has macropores. Also disclosed is a method for converting NOx in exhaust gases from motor vehicles operated with lean-burn engines.

The present invention relates to a catalyst for the reduction of nitrogen oxides contained in the exhaust gas of lean-burn combustion engines.

The exhaust gas of motor vehicles that are operated with lean-burn combustion engines, such as diesel engines, also contain, in addition to carbon monoxide (CO) and nitrogen oxides (NOₓ), components that result from the incomplete combustion of the fuel in the combustion chamber of the cylinder. In addition to residual hydrocarbons (HC), which are usually also predominantly present in gaseous form, these include particle emissions, also referred to as “diesel soot” or “soot particles.” These are complex agglomerates from predominantly carbonaceous particulate matter and an adhering liquid phase, which usually predominantly consists of longer-chained hydrocarbon condensates. The liquid phase adhering to the solid components is also referred to as “Soluble Organic Fraction SOF” or “Volatile Organic Fraction VOF.”

To clean these exhaust gases, the aforementioned components must be converted to harmless compounds as completely as possible. This is only possible with the use of suitable catalysts.

In order to remove the nitrogen oxides, so-called nitrogen oxide storage catalysts are known, for which the term, “Lean NOx Trap,” or LNT, is common. Their cleaning action is based upon the fact that, in a lean operating phase of the engine, the nitrogen oxides are predominantly stored in the form of nitrates by the storage material of the storage catalyst, and the nitrates are broken down again in a subsequent rich operating phase of the engine, and the nitrogen oxides which are thereby released are converted with the reducing exhaust gas components in the storage catalyst to nitrogen, carbon dioxide, and water. This operating principle is described in, for example, SAE document SAE 950809.

As storage materials, oxides, carbonates, or hydroxides of magnesium, calcium, strontium, barium, alkali metals, rare earth metals, or mixtures thereof come, in particular, into consideration. As a result of their alkaline properties, these compounds are able to form nitrates with the acidic nitrogen oxides of the exhaust gas and to store them in this way. They are deposited in the most highly-dispersed form possible on suitable substrate materials in order to produce a large interaction surface with the exhaust gas. In addition, nitrogen oxide storage catalysts contain precious metals, such as platinum, palladium, and/or rhodium, as catalytically-active components. It is their purpose, on the one hand, to oxidize NO to NO₂, as well as CO and HC to CO₂, under lean conditions and, on the other, to reduce released NO₂ to nitrogen during the rich operating phases, in which the nitrogen oxide storage catalyst is regenerated.

With the change in the emission regulations according to Euro 6, future exhaust gas systems will have to exhibit sufficient NOₓ conversion, both at low temperatures in urban cycles and at high temperatures, such as occur with high loads. Known nitrogen oxide storage catalysts, however, do not show a marked NOₓ storage at low or high temperatures. There is a need for catalysts that provide good NOₓ conversion over a broad temperature range of 200 to 450° C.

EP 0 885 650 A2 describes an exhaust gas purification catalyst for combustion engines with two catalytically-active layers on a support body. The layer located directly on the support body comprises one or more highly-dispersed alkaline earth oxides, at least one platinum group metal, as well as at least one fine-particle oxygen-storing material. In this case, the platinum group metals are in close contact with all components of the first layer. The second layer is in direct contact with the exhaust gas and contains at least one platinum group metal, as well as at least one fine-particle oxygen-storing material. Only a portion of the fine-particle solids of the second layer serves as a substrate for the platinum group metals. The catalyst is a three-way catalyst, which essentially converts the harmful exhaust gas components under stoichiometric conditions, i.e., with the air/fuel ratio λ of 1.

From US2009/320457, a nitrogen oxide storage catalyst is known that comprises two superimposed catalyst layers on a support substrate. The lower layer lying directly on the carrier substrate comprises one or more precious metals, as well as one or more nitrogen oxide storage components. The upper layer comprises one or more precious metals, as well as cerium oxide, and is free of alkali or alkaline earth components.

Catalyst substrates which contain nitrogen oxide storage materials and have two or more layers are also described in WO 2012/029050. The first layer is located directly on the carrier substrate and comprises platinum and/or palladium, while the second layer is located on the first layer and comprises platinum. Both layers also contain one or more oxygen-storing materials and one or more nitrogen oxide-storing materials, which comprise one or wore alkali metals and/or alkaline earth metals The total quantity of alkali metals and alkaline earth metals in the nitrogen oxide-storing materials is 11.25 to 156 g/L (0.18 to 2.5 g/in³), calculated as alkaline metal oxide M₂O and alkaline earth metal oxide MO.

Already known are catalyst coatings that, as a result of a relatively high porosity, have an improved flow with exhaust gas, and thus an improved contact of the exhaust gas components with the catalytically-active centers. Such catalyst coatings can, for example, be obtained by coating an inert support body with an aqueous coating suspension (washcoat) containing a so-called pore builder. Used as pore builders are materials that, when the catalyst is calcined following the coating, burn out without residue, and thus leave empty spaces in the coating.

Thus, US 2015/273462 describes the use of resin particles, and EP 2 050 495 A1 of synthetic resins, such as polyurethane, polystyrene, polyethylene, polyester, or acrylic ester resins, as pore builders. EP 1 832 344 A1, moreover, mentions active carbon, graphite powder, cellulose powder, organic fibers, and plastic fibers as suitable for this purpose. According to WO 2014/137827 A1, the porosity of a catalytically-active coating is increased by means of an aqueous, oil-in-water macroemulsion.

The present invention relates to a nitrogen oxide storage catalyst composed of at least two catalytically-active washcoat layers on a support body, wherein
a lower washcoat layer A contains cerium oxide, an alkaline earth compound, and/or an alkali compound, as well as platinum and palladium; and
an upper washcoat layer B arranged above washcoat layer A contains cerium oxide, as well as platinum and palladium, and is free of alkali compounds or alkaline earth compounds,

characterized in that the upper washcoat layer B has macropores of an average pore size of less than 15 μm, wherein the macropores form a pore volume in the upper washcoat layer B of 5 to 25 vol %.

The cerium oxide used in washcoat layers A and B can be of a commercially available quality, i.e., have a cerium oxide content of 90 to 100 wt %.

In embodiments of the present invention, cerium oxide is used in washcoat layer A in a quantity of 110 to 160 g/L, e.g., 125 to 145 g/L. In washcoat layer B, cerium oxide is used in quantities of 22 to 120 g/L, e.g., 40 to 100 g/L or 45 to 65 g/L.

Suitable as alkaline earth compound in washcoat layer A are, in particular, oxides, carbonates, and/or hydroxides of magnesium, strontium, and/or barium—particularly, magnesium oxide, barium oxide, and/or strontium oxide, and, more particularly, barium oxide, strontium oxide, or barium oxide and strontium oxide. Suitable as alkaline compound in washcoat layer A are, in particular, oxides, carbonates, and/or hydroxides of lithium, potassium, and/or sodium.

In embodiments of the present invention, the alkaline earth or alkali compound in washcoat layer A is present in quantities of 10 to 50 g/L—particularly, 15 to 20 g/L—calculated as alkaline earth or alkali oxide and in relation to the volume of the support body.

In embodiments of the present invention, washcoat layer A can contain manganese oxide. This is present in washcoat layer A, in particular, in quantities of 1 to 10 wt %—preferably, 2.5 to 7.5 wt %—in relation to the total of washcoat layers A and B, respectively calculated as MnO.

In other embodiments, washcoat layer B also contains manganese oxide. In these cases, the quantity of manganese oxide in washcoat layer B is up to 2.5 wt %—preferably, 0.5 to 2.5 wt %—in relation to the total of washcoat layers A and B.

Manganese oxide can serve as substrate material for the precious metals, platinum, palladium, and, where applicable, rhodium. In preferred embodiments of the present invention, however, manganese oxide does not serve as substrate material—neither for the precious metals, platinum, palladium, and, where applicable, rhodium nor for another component of washcoat layer A and, where applicable, washcoat layer B.

The term, “manganese oxide,” in the context of the present invention refers, in particular, to MnO, MnO₂, or Mn₂O₃, or combinations of MnO₂, MnO, and/or Mn₂O₃. In embodiments of the present invention, manganese oxide is not present in the form of mixed oxides with other oxides of washcoat layer A and B. Manganese oxide is, in particular not present in the form of a mixed oxide with cerium oxide, e.g., not in the form of MnOₓ—CeO₂, MnO—ZrO₂, and MnOₓ—Y₂O₃.

The ratio of platinum to palladium in washcoat layer A in embodiments of the present invention amounts to, for example, 4:1 to 18:1 or 6:1 to 16:1, e.g., 8:1, 10:1, 12:1, or 14:1.

The ratio of platinum to palladium in washcoat layer B in embodiments of the present invention also amounts to, for example, 4:1 to 18:1 or 6:1 to 16:1, e.g., 8:1, 10:1, 12:1, or 14:1, but depends upon the ratio in washcoat layer A.

In embodiments of the present invention, washcoat layer B contains rhodium as an additional precious metal. In this case, rhodium is present, in particular, in quantities of 0.003 to 0.35 g/L (0.1 to 10 g/ft³)—in particular, 0.18 to 0.26 g/L (5 to 7.5 g/ft³), respectively in relation to the volume of the support body.

The total quantity of precious metal, i.e., of platinum, palladium, and, where applicable, rhodium, in the nitrogen oxide storage catalyst according to the invention amounts, in embodiments of the present invention, to 2.12 to 7.1 g/L (60 to 200 g/ft³) in relation to the volume of the support body.

The precious metals, platinum and palladium, and, where applicable, rhodium, are usually present on suitable substrate materials in both washcoat layer A and washcoat layer B. Used as such substrate materials are, in particular, oxides with a BET surface of 30 to 250 m²/g—preferably, of 100 to 200 m²/g—(determined in accordance with DIN 66132), e.g., aluminum oxide, silicon dioxide, titanium dioxide, but also mixed oxides, such as aluminum-silicon mixed oxides and cerium-zirconium mixed oxides.

In embodiments of the present invention, aluminum oxide is used as substrate material for the precious metals, platinum and palladium, and, where applicable, rhodium—in particular, such aluminum oxide as is stabilized by 1 to 6 wt %—in particular, 4 wt %—lanthanum oxide.

It is preferable for the precious metals, platinum, palladium, and, where applicable, rhodium to be carried on only one or more of the aforementioned substrate materials and thus not to be in close contact with all components of the respective washcoat layer. In particular, manganese oxide preferably does not serve as substrate for platinum and palladium and, where applicable, rhodium.

The total washcoat loading of the support body in embodiments of the present invention amounts to 300 to 600 g/L in relation to the volume of the support body.

In embodiments of the present invention, the macropores of the upper washcoat layer B have an average pore size of 2 to 12 μm—preferably, 4 to 7 μm.

In other embodiments of the present invention, the macropores form a pore volume in the upper washcoat layer B of 5 to 20 vol %, e.g., 5 to 10 vol % or 10 to 15 vol %.

The average pore size of the macropores in washcoat layer B is generally identical to the average particle size of the pore builder used, because each particle of the pore builder used corresponds to a macropore in the calcined catalyst.

Likewise, the pore volume of washcoat layer A results as the total of the volumes of the particles of the pore builder used. The average pore size, as well as the pore volume, thus result from the size and quantity of the pore builder used and can be determined easily. Alternatively, the average pore size and pore volumes can, naturally, also be determined by the typical methods, e.g., mercury porosimetry, known to the person skilled in the art.

In a preferred embodiment, the present invention relates to a nitrogen oxide storage catalyst composed of at least two catalytically-active washcoat layers on a support body, wherein
a lower washcoat layer A contains
   cerium oxide in a quantity of 100 to 160 g/L,
   platinum and palladium in a mass ratio of 10:1, as well as
   magnesium oxide and/or barium oxide; and
an upper washcoat layer B is arranged above lower washcoat layer A and contains
   no alkaline earth compound and no alkali compound,
   platinum and palladium in a mass ratio of 10:1, as well as
   cerium oxide in a quantity of 45 to 65 g/L,

wherein the quantity g/L respectively relates to the volume of the support body and wherein the upper washcoat layer B has macropores of an average pore size of 2 to 12 μm and wherein the macropores form a pore volume in the upper washcoat layer B of 5 to 20 vol %.

In a particular embodiment of this type, washcoat layer A contains manganese oxide in a quantity of 5 to 15 g/L.

In another particular embodiment of this type, washcoat layer A is present in quantities of 250 to 350 g/L and washcoat layer B in quantities of 80 to 130 g/L.

The catalytically-active washcoat layers A and B are applied to the support body using a coating suspension in accordance with the customary dip coating methods or pump and suck coating methods with subsequent thermal post-treatment (calcination and, where applicable, reduction using forming gas or hydrogen). These methods are sufficiently known from the prior art.

In a first step, the coating suspension for washcoat layer A is applied in the appropriate quantity to the support body and dried. In a second step, the coating suspension for washcoat layer B is applied in the appropriate quantity to the support body already coated with washcoat layer A and is also dried. The completely coated support body is subsequently calcined.

The necessary coating suspensions can be obtained in accordance with methods known to the person skilled in the art. The components, such as cerium oxide, alkaline earth and/or alkali compound, precious metals carried on suitable substrate materials, as well as, where applicable, manganese oxide or another manganese compound, are suspended in the appropriate quantities in water and ground in a suitable mill—in particular, a ball mill—to a particle size of d₅₀=3 to 5 μm. It is preferable to add manganese in the form of manganese carbonate to the coating suspension in the last step, i.e., directly prior to grinding.

In order to produce the macropores, pore builders are added to the coating suspension for washcoat layer B. This addition preferably takes place after grinding the coating suspension to a particle size of d₅₀=3 to 5 μm.

The pore builders consist of materials that burn out completely and without residue from approximately 350° C. during calcination of the completely coated support body and thus leave macropores.

Suitable pore builders consist, in particular, of synthetic resins, such as polyurethane, polystyrene, polyethylene, polyester, polyacrylonitrile, or polyacrylic ester resins. Particularly preferred are pore builders of polymethylmethacrylate or of polyacrylonitrile.

In order to obtain macropores of the pore size according to the claims, the pore builders must have an average particle size of less than 15 μm, e.g., 2 to 12 μm—preferably, 4 to 7 μm.

In order to obtain the pore volume according to the claims formed by the macropores, pore builders in the appropriate quantity must be added to the coating suspension for producing washcoat layer B. The appropriate quantity can easily be determined from the average particle size of the pore builders.

Suitable pore builders are known and commercially available.

The nitrogen oxide storage catalysts according to the invention are very well-suited for the conversion of NO in exhaust gases of motor vehicles that are operated with lean-burn engines, such as diesel engines. They achieve a good NOx conversion at temperatures of approx. 200 to 450° C., without the NOx conversion being negatively affected at high temperatures. The nitrogen oxide storage catalysts according to the invention are thus suitable for Euro 6 applications.

The present invention thus also relates to a method for converting NOₓ in exhaust gases of motor vehicles that are operated with lean-burn engines, such as diesel engines, which method is characterized in that the exhaust gas is guided over a nitrogen oxide storage catalyst composed of at least two catalytically-active washcoat layers on a support body, wherein
a lower washcoat layer A contains cerium oxide, an alkaline earth compound, and/or an alkali compound, as well as platinum and palladium; and
an upper washcoat layer B arranged above washcoat layer A contains cerium oxide, as well as platinum and palladium, and is free of alkali compounds or alkaline earth compounds,

characterized in that the upper washcoat layer B has macropores of an average pore size of less than 15 μm, wherein the macropores form a pore volume in the upper washcoat layer B of 5 to 25 vol %.

Embodiments of the method according to the invention with respect to the nitrogen oxide storage catalyst correspond to the descriptions above.

The invention is explained in more detail in the examples and figures below.

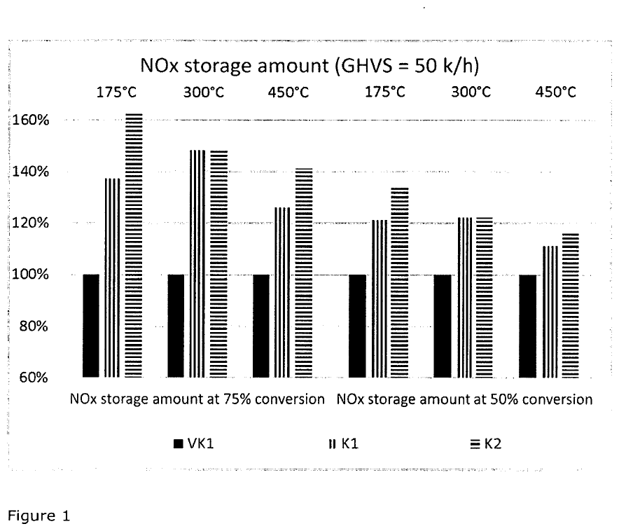

FIG. 1: NOx storage amount in g/L at 50% and at 75% of the catalysts K1, K2, and VK1.

### EXAMPLE 1

a) In order to produce a catalyst according to the invention, a commercially available, honeycombed, ceramic substrate is coated with a first coating suspension containing Pt and Pd carried on aluminum oxide, cerium oxide in a quantity of 125 g/L, 21 g/L barium oxide, 15 g/L magnesium oxide, and 7.5 g/L MnO in the form of manganese carbonate. In this case, the loading of Pt and Pd amounts to 1.236 g/L (35 g/ft³) and 0.124 g/L (3.5 g/ft³), and the total loading of the washcoat layer is approximately 293 g/L in relation to the volume of the ceramic substrate. After coating, the obtained washcoat layer A was dried.

b) Another washcoat layer B was applied to the first washcoat layer A. For this purpose, the coating took place with a coating suspension that also contained Pt and Pd carried on aluminum oxide, as well as Rh carried on a lanthanum-stabilized aluminum oxide. The loading of Pt, Pd, and Rh in washcoat layer B thus amounted to 1.236 g/L (35 g/ft³), 0.124 g/L (3.5 g/ft³), and 0.177 g/L (5 g/ft³). The coating suspension moreover contained 55 g/L cerium oxide in a washcoat loading of layer B of approximately 81 g/L in the calcined catalyst.

In addition to the aforementioned components, the coating suspension also contained 5 g/L of a pore builder composed of a cross-linked polymethylmethacrylate resin of an average particle size of 5 to 7 μm. The coating was dried, and calcination took place thereafter. After calcination, the pore volume in washcoat layer B was 6.5 vol %.

The catalyst thus obtained is referred to below as K1.

### EXAMPLE 2

Example 1 was repeated, with the difference that the coating suspension for washcoat layer B contained the pore builder in a quantity of 7.5 g/L pore builder. After calcination, the pore volume in washcoat layer B was 9.7 vol %.

The catalyst thus obtained is referred to below as K2.

### COMPARATIVE EXAMPLE 1

Example 1 was repeated, with the difference that the coating suspension for washcoat layer B did not contain any pore builder. The catalyst thus obtained is referred to below as VK1.

Comparative Tests

a) The catalysts K1, K2, and VK1 were aged hydrothermally for 16 hours at 800° C.

b) Their nitrogen oxide storage capacity was, subsequently, respectively determined as follows:

First, the sample was conditioned at 450° C. To this end, a lean gas composition according to table 1 and a rich gas composition were alternatingly guided over the catalyst for 80 s and 10 s respectively for a duration of 15 min.

TABLE 1

| | Lean | Rich | Adsorption |
|---|---|---|---|
| GHSV [1/h] | 50,000 | 50,000 | 50,000 |
| NO [ppm] | 0 | 0 | 500 |
| O₂ [vol %] | 8 | 0 | 8 |
| CO [ppm] | 0 | 40,000 | 0 |
| CO₂ [vol %] | 10 | 10 | 10 |
| H₂O [vol %] | 10 | 10 | 10 |

The sample was subsequently cooled in a nitrogen atmosphere to measuring temperature (175° C. or 300° C.) or kept at 450° C. At a constant measuring temperature, the NOx adsorption in the gas composition “Adsorption” according to table 1 is then measured. The NOx storage capacity is calculated from the difference in the dosed NOx amount in relation to the catalyst volume from the amount of NOx slip measured behind the catalyst sample in relation to the catalyst volume at that point in time when the NOx conversion over the sample is 75% or only 50%, and is illustrated in FIG. 1 as NOx storage amount.

As a result, the NOx storage amount in g/L at 50% and at 75% conversion was specified, wherein the storage amounts of VK1 were respectively set to 100%, and the storage amounts of K1 and K2 were related thereto.

The results can be taken from FIG. 1.

### EXAMPLE 3

Example 1 was repeated, with the difference that the coating suspension for washcoat layer B contained 5 g/L of a pore builder composed of a cross-linked polymethylmethacrylate resin of an average particle size of 8 to 12 μm.

### EXAMPLE 4

Example 1 was repeated, with the difference that the coating suspension for washcoat layer B contained 7.5 g/L of a pore builder composed of a cross-linked polymethylmethacrylate resin of an average particle size of 4 to 5 μm.

Other examples are listed in Table 2

| | CeO₂ | CeO₂ | MnO | MnO | Pore |
|---|---|---|---|---|---|
| | Washcoat | Washcoat | Washcoat | Washcoat | builder/ |
| | A | B | A | B | quantity in |
| Example | [g/L] | [g/L] | [g/L] | [g/L] | (g/L) |
| 5 | 110 | 25 | 5 | 1 | a/7.5 |
| 6 | 125 | 40 | — | — | c/5 |
| 7 | 140 | 60 | 2.5 | — | b/5 |
| 8 | 155 | 100 | 2.5 | 2.5 | c/5 |
| 9 | 155 | 22 | 7.5 | 0.5 | b/7.5 |
| 10 | 110 | 129 | — | — | a/5 |

In Table 2:
“a” means pore builder composed of a cross-linked polymethylmethacrylate resin of an average particle size of 8 to 12 μm.
“b” means pore builder composed of a cross-linked polymethylmethacrylate resin of an average particle size of 5 to 7 μm.
“c” means pore builder composed of a polyacrylonitrile resin of an average particle size of 8 μm.

1. Nitrogen oxide storage catalyst composed of at least two catalytically-active washcoat layers on a support body, wherein
a lower washcoat layer A contains cerium oxide, an alkaline earth compound, and/or an alkali compound, as well as platinum and palladium; and
an upper washcoat layer B arranged above washcoat layer A contains cerium oxide, as well as platinum and palladium, and is free of alkali compounds or alkaline earth compounds,
characterized in that the upper washcoat layer B has macropores of an average pore size of less than 15 μm, wherein the macropores form a pore volume in the upper washcoat layer B of 5 to 25 vol %.

2. Nitrogen oxide storage catalyst according to claim 1, characterized in that washcoat layer A contains cerium oxide in a quantity of 110 to 160 g/L.

3. Nitrogen oxide storage catalyst according to claim 1, characterized in that washcoat layer B contains cerium oxide in a quantity of 22 to 120 g/L.

4. Nitrogen oxide storage catalyst according to claim 1, characterized in that the alkaline earth compound in washcoat layer A is an oxide, carbonate, and/or hydroxide of magnesium, strontium, and/or barium.

5. Nitrogen oxide storage catalyst according to claim 1, characterized in that the alkaline earth compound in washcoat layer A is magnesium oxide, barium oxide, and/or strontium oxide.

6. Nitrogen oxide storage catalyst according to claim 1, characterized in that the alkaline earth or alkali compound in washcoat layer A is present in quantities of 10 to 50 g/L, calculated as alkaline earth or alkali oxide and in relation to the volume of the support body.

7. Nitrogen oxide storage catalyst according to claim 1, characterized in that washcoat layer A contains manganese oxide.

8. Nitrogen oxide storage catalyst according to claim 7, characterized in that manganese oxide is present in washcoat layer A in quantities of 1 to 10 wt % in relation to the total of washcoat layers A and B and calculated as MnO.

9. Nitrogen oxide storage catalyst according to claim 1, characterized in that the ratio of platinum to palladium in washcoat layer A and in washcoat layer B is respectively 4:1 to 18:1, independently of each other.

10. Nitrogen oxide storage catalyst according to claim 1, characterized in that washcoat layer B contains rhodium.

11. Nitrogen oxide storage catalyst according to claim 10, characterized in that rhodium is present in quantities of 0.003 to 0.35 g/L in relation to the volume of the support body.

12. Nitrogen oxide storage catalyst according to claim 1, characterized in that the macropores of the upper washcoat layer B have an average pore size of 2 to 12 μm.

13. Nitrogen oxide storage catalyst according to claim 1, characterized in that the macropores form a pore volume in the upper washcoat layer B of 5 to 10 vol %.

14. Nitrogen oxide storage catalyst according to claim 1, characterized in that the macropores form a pore volume in the upper washcoat layer B of 10 to 15 vol %.

15. Method for converting NOₓ in exhaust gases of motor vehicles that are operated with lean-burn engines, characterized in that the exhaust gas is guided over a nitrogen oxide storage catalyst according to claim 1.
